(19) United States
(12) Patent Application Publication
(10) Pub. No.: US 2025/0392074 A1
(43) Pub. Date: Dec. 25, 2025

(54) Mobile Device Charging Cable for Keychain

(71) Applicant: Yeoshua Soriasky, Brooklyn, NY (US)

(72) Inventor: Yeoshua Soriasky, Brooklyn, NY (US)

(21) Appl. No.: 18/952,212

(22) Filed: Nov. 19, 2024

Related U.S. Application Data
(63) Continuation-in-part of application No. 29/948,649, filed on Jun. 21, 2024.

(51) Int. Cl. H01R 13/60; H01B 7/40

(52) U.S. Cl. CPC H01R 13/60; H01B 7/40

(57) ABSTRACT

A flat charging cable and a matching cable housing cap with append structure capable of attaching the cable to a keychain for easy carrying on a person.

### CROSS-REFERENCE TO RELATED APPLICATIONS

This application claims the priority to the U.S. Design patent application Ser. No. 29/948,649,filed on Jun. 21, 2024, the entirety of which is therefore incorporated by reference.

### BACKGROUND OF THE INVENTION

The present application relates to a charging cable for mobile devices. More particularly this application is about a charging cable that is configured with the capacity to be carried on a keychain. Note that the points discussed below may reflect the hindsight gained from the disclosed inventions, and are not necessarily admitted to being prior art.

In the digital age, almost everyone owns a cell phone and one or more mobile devices, charging cables are invariably generally used for charging these mobile devices. While wireless charging has been commercially developed and commercially available, cable charging is still the most efficient and safe way to charge a mobile device. However, the current charging cables do not offer a structure that can allow the charging cable to be personally carried on. Possibly due to their straightforward and simple function, there have not been design improvements for charging cables. Charging cables are usually stored and carried separately from mobile devices, they can easily get lost or misplaced or forgotten to be carried with the mobile devices. As a solution, many people purchase multiple charging cables to place them at different locations. But people still end up making emergency purchases for charging cables when they cannot find them or forget to bring them. Many people even have developed habitual anxiety over forgetting bringing charging cable with the phone. As most people carry a set of keys with a key chain and people seldomly forget to carry their keys with them, there is a need to treat a charging cable as a necessity like a key, to improve the current charging cable with structures for carrying on a keychain.

### SUMMARY OF THE INVENTION

The present patent application discloses a charging cable set for mobile devices that is capable of being carried on a keychain. In one embodiment, the cable set comprises a charging cable and a socket head housing structure that has housing a circular ring head capable of hooking onto a keychain. In one aspect, the socket head housing is configured with two sockets that match the two charging terminals of the charging cable. In one aspect, the charging cable has two or more different charging ports and plugs, they may be conformed with the standard Micro USB, Type-C, and Lightning or special customized ports and plugs. In another aspect, the charging able body is flexibly configured with a section of rubber or similar material to bend easily. In another aspect, the charging cable is configured in a belt shape, so that it folds easily and stays in folding status to be carried personally on a keychain or belt. In another aspect, the charging cable is configured with two magnetic nuggets in the cable body that keep the charging cable in folding when it is attached to the socket head on a keychain. The disclosed charging cable set, in various embodiments, provides the capacity to be carried on a keychain.

### BRIEF DESCRIPTION OF DRAWINGS

The disclosed application will be described with reference to the accompanying drawings, which show important sample embodiments of the invention, and which are incorporated in the specification hereof by reference, wherein:

FIG. 1 shows an example embodiment of a charging cable set in accordance with this application.

FIG. 2 shows a side view of an example socket housing head portion in accordance with this application.

FIG. 3 shows a bottom view of an example socket housing head portion in accordance with this application.

FIG. 4 shows a perspective view of an example socket housing head portion in accordance with this application.

FIG. 5 shows a top view of an example charging cable in accordance with this application.

FIG. 6 shows a side view of an example charging cable from the terminal side in accordance with this application.

FIG. 7 shows a prospective view of an example charging cable in accordance with this application.

FIG. 8 shows a side view of an example charging cable in accordance with this application.

FIG. 9 shows an example cable set with folded cable attached on a keychain in accordance with this application.

FIG. 10A shows a folding process of an example charging cable in accordance with this application.

FIGS. 10B-10D shows various views of a folded charging cable in accordance with this application.

### DETAILED DESCRIPTION OF THE INVENTION

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements but may include other elements not expressly listed or inherent to such process, method, article, apparatus, or composition. The material for the charging cable and the socket housing head portion can be made with any suitable material, for example, thermoplastic elastomer (TPE), polyvinyl chloride (PVC) and nylon braid, plastic, rubber and woven nylon, TPU, silicon, EPR, CPE/CR, or any other material that is available in the future.

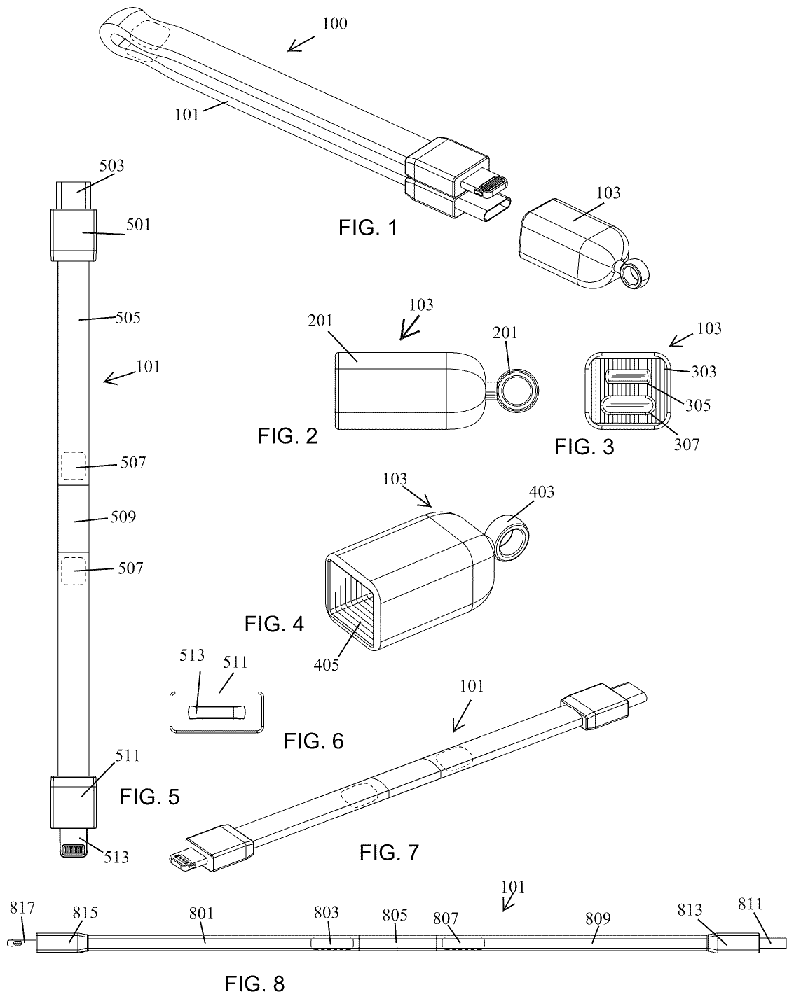

In reference to FIG. 1, an example charging cable set 100 comprises two portions, the charging cable portion 101 and a socket housing head portion 103. Charging cable 101 and socket housing head portion 103 are further described in the additional figures. In reference to FIG. 2, a socket housing head portion 103 is configured with a circular ring head or tip 203 that can hook the socket housing head portion to a key ring. Ring head 203 may be configured in other shapes, such as rectangular ring, oval, triangle, or with other ornamental elements, emblemed with people's initial or formed with people's initial letters, special symbols, animals etc. An example socket housing head portion 103 also comprises a housing body 201 that has an opening at one end of tubular body 405 as shown in FIG. 4. Within the tubular housing body 405, one or two or more sockets, favorably at least two sockets, are constructed for plugging-in the plug terminals of the charging cable 101. Ring head 203 may be constructed as a large size similar to a key ring to function as a key ring simultaneously or sized minimally to simply function as a ring tip to be hooked to another key ring.

In reference to FIG. 3, two different types of sockets 303 and 305 may be constructed. Socket 303 may accommodate LIGHTNING type plug, socket 305 may accommodate Type C plugs. Other types of sockets may be constructed to accommodate other types of connector-plugs of the charging cable 101. Housing body 405 may be constructed as a rectangular shaped tubular (as shown in FIG. 4) or a cylinder shaped in the size of a pen cap or in the size of a highlighter cap. The sockets 303 and 305 shown in FIG. 3 are constructed at the bottom within the tube structure of housing body 405.

In reference to FIGS. 5, 6, 7 and 8, the charging cable 101 is constructed preferably as a thin belt shaped cable 505 with a flexible and bendable middle area 509 flanked by two embedded magnet nuggets 507. The middle area 509 may be made of a rubber-like material for durability and flexibility. The charging cable 101 is also constructed with charging connector plugs, preferably at both ends 501 and 511 with preferably different connector plug types 503 and 513. The charging cable may be customized with multiple connectors plugs for being multi-functional charging cable for fit different sockets standard of mobile devices. For example, connector plug 503 may be a Type C plug and connector plug 513 may be LIGHTNING type. The charging cable 101, like a USB cable, can comprise a set of insulated wires, including positive power, negative power, and data lines, bundled together within a protective jacket, with connectors at each end designed to fit specific ports on different devices and to fit the sockets in the head housing portion 103 to carry on with a key ring or key chain. In charging cable 101, the pins of connectors 503 or 513 make contact with the corresponding wires to transfer power and data. The charging cable 101 may also be constructed to have terminal connector plugs for USB-A ports, USB-B, USB-C, USB-mini, Micro-USB ports with different chapes, for example, USB-C ports are oval in shape, USB-A ports are rectangular with different configurations. USB-C cables can fit either way while USB 2.0 and USB 3.0 cables have a “right side up” cables only fit in one way to a charging socket of a device.

The charging cable 101 may be constructed with multiple layers of materials, the outer layer material may be constructed with braided shielding net, aluminum foil and copper core. The innermost layer may be covered with a colored insulating jacket material to transmit data signals and current, and plastic shell may be used to protect the wires. The braided mesh and aluminum foil layer may be used for shielding. The type of jacket material plays an important role in protecting the inner structure of the cable as a shield in the external environment, protecting the wires from damage. In a preferred embodiment, because an interference electromagnetic field is generated from around the passing current when charging or transferring data at high speed, the shielding net layer prevents it from spreading outward and prevents it from affecting other components. The aluminum foil is the same as that of the shielding net. High-quality data cables may be wrapped with these two layers of media. At the same time, the aluminum foil can also have a certain heat insulation effect. For standard data cable, there must be 4 connecting wires inside. These wires are not only responsible for current transmission but also for transmitting data signals, there must be another metallic wire core. In general, the quality of the wire core is respectively: iron core<iron core galvanized<iron core copper-plated<copper wire. The quality and material of the copper core determine the performance of the data line. Copper wire core material is the best choice because of its excellent data transmission capabilities. The charging cable described herein can be built with the standards for EV charging connectors are IEC 62196 (Type 1 and Type 2) and IEC 61851 for communication and control protocols. The charging cable can work with 20 W or higher USB-C power adapter or higher-wattage USB-C power adapter. The charging cable may also comply with IEC60245 and IEC60227 standards from the International Electrotechnical Commission (IEC), the Article400 standard in the United States that is based on the UL62 flexible cable standard from the United States UL Company.

Each connecting line is wrapped by insulating material (PE). The common core specifications in the market were 6 cores, 8 cores, and 10 cores in one line, and the cores may also be 12 cores, 16 cores, 24 cores, 32 cores and 40 cores. More cores generally mean better performance, allowing more data and current to pass through. There is a ground wire known as neutral wire, it functions to ensure that the potential of the circuit is stable, thereby ensuring the reliability of data transmission. The wires may include “read the data line” (Data+ or USB Port+), it carries the data signal sent from the device, telling the receiving device “I have some data to send to you”, as a signal output line; and “write data line” (Data− or USB Port−) as a signal input line that receives data signals from other devices and acts like an ear for listening to information sent by other devices. The wires include a “power line” (VCC or VBUS) with +5V DC power supply, as the positive line of the power supply, this line connects to the “power source” of the charging cable, providing the power required by the mobile device to ensure that the device can function and charge normally.

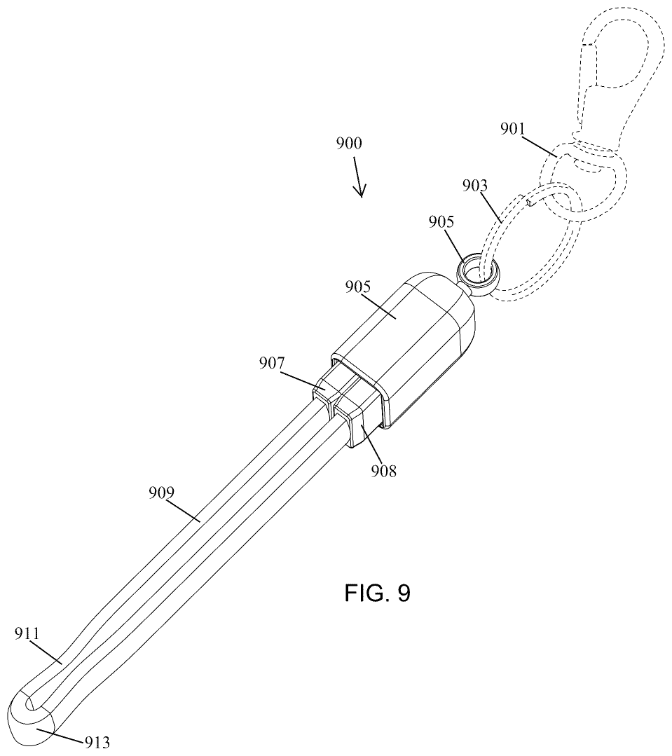

Preferably the present charging cable is designed to have a thin belt-like structure where the wires are not bundled like a rope or string but may be arranged horizontally to allow for more flexibility and bending as shown in FIGS. 5 and 8. In reference to FIG. 9, the charging cable set 900 is configured to be carried onto a key ring 903 through the socket housing head ring 905 and housing head 906, where the cable's two connector terminals 907 and 908 are plugged into the sockets inside the socket housing head 906. To further render the belt-like cable more flexible, the middle area 913 may be constructed with rubber or carbon fiber material or other durable and flexible material. To keep the charging cable in folding position when in non-use carrying on status, two magnetic nuggets 911 may be embedded to keep the two folded sides attached to each other.

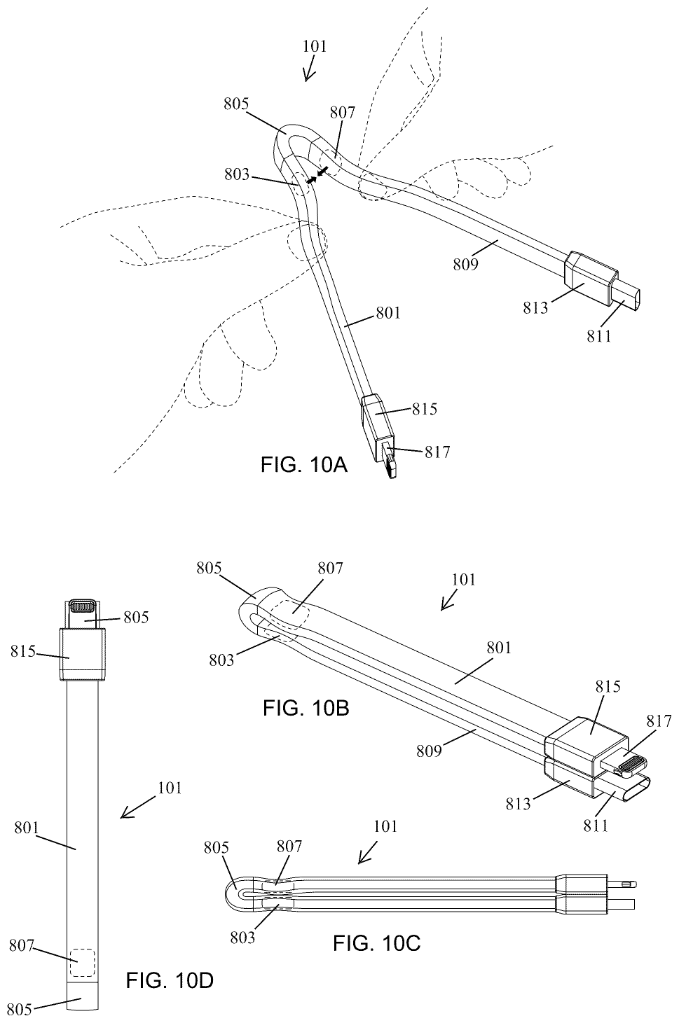

In reference to FIG. 10A, when in use, cable 101 may be unplugged from the housing head 103 and sides 801 and 809 be stretched open with hands and magnets 803 and 807 be thus detached from each other. The bended area 805 is thus straightened to allow connectors 817 and 811 to connect to power source and mobile devices. In reference to FIG. 10B to 10D, the magnets 803 and 807 are placed in such a manner when the charging cable 101 is bent at area 805, the attraction of the magnets will keep the charging cable bent and folded together and the connectors 817 and 811 can be fit into a matching housing head 103 for carry onto a keychain.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the descriptions in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A charging cable for carrying on a keychain comprising:
a socket housing head portion having an append structure capable of attaching to a keychain and a housing body constructed with a socket that matches a charging connector; and
a charging cable having a flat cable body with a width larger than thickness and at least one charging connector configured at one end of said cable body wherein said connector fits to said socket of said socket housing head portion, wherein said charging cable is configured to connect a mobile device to a charging power source for battery charging.

2. The charging cable of claim 1 further comprising at least two magnetic nuggets attached to the cable body wherein the charging cable remains in folding position by the two magnetic nuggets attracting force.

3. The charging cable of claim 1 wherein the append structure is a circular ring.

4. The charging cable of claim 1 wherein the append structure is a rectangular ring.

5. The charging cable of claim 1 wherein the append structure is a locking hook.

6. The charging cable for claim 1 wherein said charging cable is configured with two different charging connectors.

7. The charging cable for claim 6 wherein one charging connector is USB-A type and one charging connector is USB-C type.

8. The charging cable for claim 6 wherein one charging connector is USB-C type and one charging connector is LIGHTNING type.

9. The charging cable of claim 1 wherein the append structure is made of metal.

10. The charging cable of claim 1 wherein the append structure is made of plastics.

11. The charging cable of claim 1 wherein the socket housing head portion is made of metal.

12. The charging cable of claim 1 wherein the socket housing head portion is made of plastics.

13. The charging cable of claim 1 wherein the socket housing body is configured with two sockets for holding two charging connectors.

14. The charging cable of claim 1 wherein said socket housing body is configured in a shape of pen cap having a socket structure at the bottom of the housing body inside.

15. The charging cable of claim 1 wherein said charging cable comprises wires arranged in parallel to form a flat charging cable.
